(19) United States
(12) Patent Application Publication
(10) Pub. No.: US 2024/0140247 A1
(43) Pub. Date: May 2, 2024

(54) SMART CHARGING STATION ADAPTER FOR RESIDENTIAL EV CHARGING STATION

(71) Applicant: EVJAM LLC, Minneapolis, MN (US)

(72) Inventors: Gregg KROMREY, Hudson, WI (US); Steven DICKE, Minneapolis, MN (US)

(73) Assignee: EVJAM LLC, Minneapolis, MN (US)

(21) Appl. No.: 18/385,205

(22) Filed: Oct. 30, 2023

Related U.S. Application Data
(60) Provisional application No. 63/420,886, filed on Oct. 31, 2022.

(51) Int. Cl. B60L 53/66

(52) U.S. Cl. CPC B60L 53/66

(57) ABSTRACT

One or more examples provide a smart charging station adapter that converts an EV charging station from a single vehicle charging station into a multi-vehicle charging station.

### CROSS REFERENCE TO RELATED APPLICATION

This Non-Provisional Patent Application claims the benefit of the filing date of U.S. Provisional Patent Application Ser. No. 63/420,886, filed Oct. 31, 2022, which is herein incorporated by reference.

### TECHNICAL FIELD

The present disclosure relates generally to examples of electric vehicles and to devices for use with an electric vehicle, including electric vehicle batteries and electric vehicle charging devices.

### BACKGROUND

Electric vehicles (EVs), such as automobiles (e.g., cars and trucks), watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a rechargeable battery system, one or more electrical motors, each with a corresponding electronic power inverter (sometimes referred to as a motor controller), and various auxiliary systems (e.g., cooling systems). To enhance ownership and ensure availability, charging of EVs should be both timely and convenient.

For these and other reasons, there is a need for the present invention.

### SUMMARY

The present disclosure provides one or more examples of an electric vehicle and systems and/or devices for use with an electric vehicle.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems.

FIG. 1 is a block and schematic diagram generally illustrating a smart charging station adapter, according to examples of the present disclosure.

FIG. 2 is a block and schematic diagram generally illustrating a smart charging station adapter, according to examples of the present disclosure.

FIG. 3 is a block and schematic diagram generally illustrating a smart charging station adapter, according to examples of the present disclosure.

FIG. 4 is a block and schematic diagram generally illustrating a residential vehicle load management system, according to examples of the present disclosure.

FIG. 5 is a block and schematic diagram generally illustrating a residential vehicle load management system in conjunction with a smart charging station adapter, according to examples of the present disclosure.

FIG. 6 is a block and schematic diagram generally illustrating a residential vehicle load management system with smart metering, according to examples of the present disclosure.

FIG. 7 is a block and schematic diagram generally illustrating a residential electric vehicle charging station with load management and smart metering features, according to examples of the present disclosure.

FIG. 8 is a graph generally illustrating a dynamically adjusted rate of charging of an electrical vehicle by a residential vehicle load management system with smart metering, according to examples of the present disclosure.

FIG. 9 is a block and schematic diagram generally illustrating a residential electric vehicle charging station with load management and smart metering features, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

The following disclosure includes one or more examples of electric vehicles (EVs) with charging port devices and charging port devices and/or charging devices/systems for use with electric vehicles. One or more features of electric vehicle systems and devices are described in further detail in the following paragraphs and illustrated in the Figures. In particular, the present disclosure provides examples of an electric vehicle charging system having a smart charging station adapter and a residential vehicle load management system.

Conventional electric vehicle (EV) charging systems are typically configured as a single charging device which is dedicated to charging a single EV at a charging location, such as within a residential garage or driveway/parking location, for example. If a user having multiple EVs wishes to avoid the costs of purchasing and installing a dedicated charging station for each EV, the user must rotate which EV is connected to the charging station at a given time in order to charge each EV. If multiple vehicles need to be charged, such a scenario could potentially require an owner to get up during the night to switch which vehicle is connected to the charger (which may require physical repositioning of the vehicle). If, instead, the owner purchases multiple chargers, simultaneously charging multiple vehicles could potentially result in an electrical overload condition, particularly in the case of a residential electrical service.

According to the present application, the smart charging station adapter enables a single charging station to be simultaneously connected to multiple vehicles and to charge the multiple vehicles either sequentially or simultaneously. As a result, a smart charging station adapter, according to the present application, enables a user having multiple electric vehicles to purchase and install a single electric vehicle charging station to charge multiple electric vehicles, thereby avoiding costs and difficulties in having to purchase and install a dedicated electric charging station for each electrical vehicle. For example, a person already having an electric vehicle and a corresponding charging station can purchase an additional electric vehicle without needing to purchase and install an additional charging station by installing a smart charging station adapter that enables the already installed charger to charge both vehicles.

### Smart Charging Station Adapter

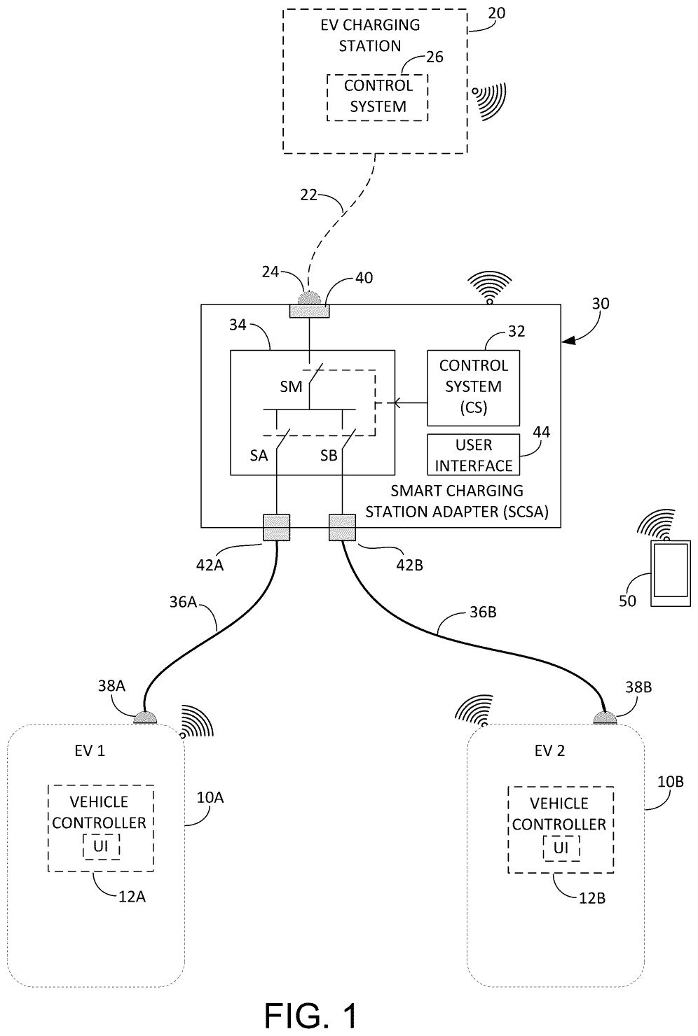

FIG. 1 is block and schematic diagram generally illustrating a smart charging station adapter (SCSA) 30 which is connectable to and enables a single charging device 20 (e.g., a Level 2 charger, a DC fast charger, etc.) to charge one or more (e.g., 1, 2, 3, etc.) electric vehicles (EVs) 10, such as illustrated by EVs 10A and 10B, either simultaneously or sequentially, over a period of time. In examples, SCSA 30 includes a control system (CS) 32, and a switching module 34 which includes one or more switches which are controllable by CS 32. In the illustrated example, switching module 34 includes a main switch, SM, and charging switches SA and SB.

In one example, a charging cord/plug 22/24 of existing EV charging station 20 is plugged into an input port 40 of SCSA 30 which, in one example, is connected to main switch SW. In examples, input port 40 is adapted to receive the plug 24 of charging cord 22 of EV charging station 20. In examples, input port 40 is modular and may be replaced with a receptacle configuration to match that of plug 24. In examples, EV charging station may have previously been purchased and installed by a user (EV owner) and mounted at a charging location, such as within a residential garage, for instance.

In examples, charging switches SA and SB are respectively connected to charging cords 36A and 36B having charging plugs 38A and 38B via corresponding output charging ports 42A and 42B. Although illustrated as having two controllable switches SA and SB selectively providing charging power to corresponding output ports, 42A and 42B, in other examples, SCSA 30 may include more than two controllable switches and output port to enable connection to more than two EVs.

In examples, a user interface (UI) 44 enables a user to locally control a set-up and operation of SCSA 30 (e.g., program/set charging parameters such as the charging port, charging voltage levels, desired charge level (%) of battery, desired date/time of completion of charging operation). In other examples, set-up and operation of SCSA 30 may be performed remotely via an application installed on a mobile device 50 (e.g., a smartphone) or via control systems and UIs 12A/12B of the EVs 10A and 10B. In examples, SCSA 30 may communicate wirelessly (such as via Bluetooth and Bluetooth low energy, for example) with EV charging station 20 and/or EVs 10A and 10B, or may communicate through a wired connection via charging cables 22 and 36A/36B.

In operation, as will be described below, SCSA 30 serves as an intermediary to control the charging of multiple EVs, such as EVs 10A and 10B, via EV charging station 20. In some examples, SCSA 30 controls charging operations so that EVs 10A and 10B are charged sequentially wherein only one of the EVs 10A and 10B are electrically connected to EV charging station 20 via controllable switches SA and SB at a given time. In other examples, SCSA controls charging operation so that EVs 10A and 10B may be simultaneously charged.

During operation, according to one example, charging information/criteria is communicated between SCSA 30 and EVs 10A and 10B via wired connections (e.g., via charging cables 36A and 36B), wireless connections (e.g., via Bluetooth and Bluetooth low energy). In some examples, SCSA 30 communicates with EVs 10A and 10B upon charging cords 36A and 36B being plugged into EVs 10A and 10B. In examples, default settings may be employed by SCSA 30 for the charging of EVs 10A and 10B. In other examples, users may adjust/override default settings by providing control parameters to control system 32 locally via user interface 44 or remotely via a user interface/application via EV control systems 10A and 10B or via an application on a mobile device 50. Examples of such user inputted control parameters may include a desired date/time by which the charging operation needs to be complete, a voltage at which the charging operation should be performed, and a level to which the battery should be charged (e.g., a desired percentage of full charge, such as 80% for instance).

In some examples, if both vehicles are simultaneously plugged into SCSA 30, based on the charging operation control parameters, even though EV 2 may have been plugged into SCSA 30 prior to EV 1 and may still be undergoing a charging operation, control system 32 may interrupt the charging of EV2 and begin a charging operation of EV 1 (e.g., EV 1 is going to be driven sooner than EV 2 and, thus, needs to be charged first). Once the charging operation of EV 1 is completed, control system 32 resumes the charging operation of EV 2. In other examples, SCSA 30 simply charges EV1 and EV 2 on a first come, first serve basis.

According to examples, SCSA 30 controls the initiation of charging operations of EVs connected thereto (such as EV 1 and EV2) by EV charging station 20. In examples, when initiating the charging of a first vehicle, such as EV 1, SCSA 30 transmits the vehicle charging information to EV charging station 20 (either via wired or wireless communication) and connects the EV, in this example, EV 1, to charging station 20 by closing controllable switch SA. When the charging of EV1 is complete, SCSA 30 automatically opens controllable switch SA, transmits the vehicle charging information of EV 2 to EV charging station 20, and closes controllable switch SB to connect EV charging station 20 to EV 2. In some examples, a status of charging operations may be wireless transmitted to remove devices (such as smartphone 50), such as via Bluetooth or cellular communications.

As such, SCSA 30 serves as a smart pass-through device (or a smart charging multiplexer) to enable the single EV charging station 20 to charge multiple vehicles at multiple locations (e.g., the vehicles do not need to be relocated to a designated charging space to undergo charging. SCSA 30 enables a user to charge multiple vehicles without requiring the user to return to the charging location to transfer the charging plug of EV charging station 10 from one vehicle to another to carry out charging operations.

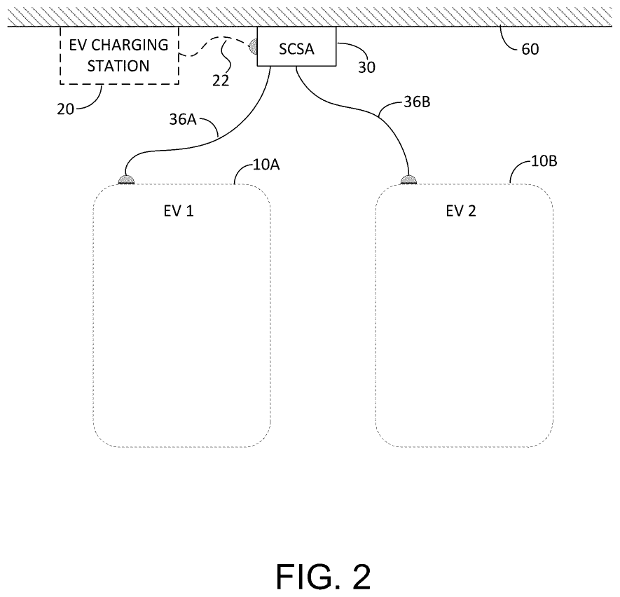

With reference to FIG. 2, in one example of a residential charging application, the single EV charging station 20 is mounted to a wall of a residential garage 60. An SCSA 30, in accordance with the present disclosure, can be mounted near EV charging station 20, with EV charging station 20 being plugged into SCSA 30 via charging cord 22. Two EVs 10A and 10B are parked side-by-side in the garage near SCSA 30 and respectively plugged into SCSA via charging cords 36A and 36B. SCSA 30 carries out controlled charging of EVs 10A and 10B based on defined vehicle charging parameters (e.g., default or user entered) using the single EV charging station 20.

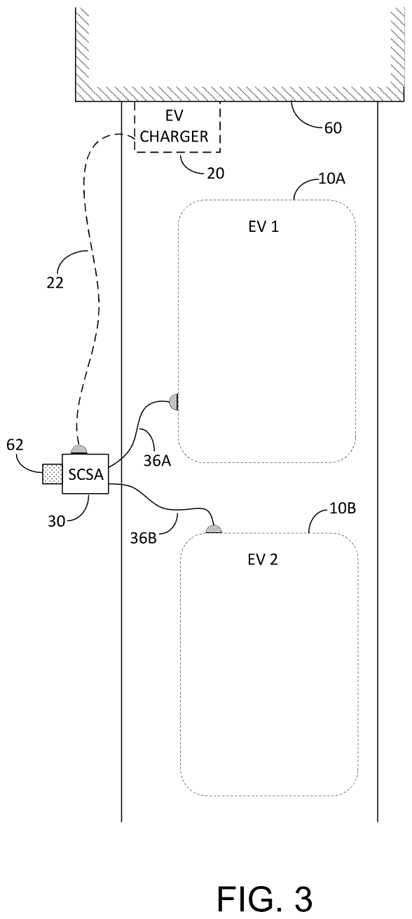

With reference to FIG. 3, in another example of a residential application, EVs 10A and 10B may be parked end-to-end on a driveway. In such example, SCSA 30 may be mounted at a location along the driveway between EVs 10A and 10B, such as on a post 62, and plugged into EV charging station 20 via charging cord 22. SCSA 30 is plugged into EVs 10A 10B via charging cords 36A and 36B for controlled charging by the single EV charging station 20 via SCSA 30.

It is noted that any number of installation scenarios and locations are contemplated, wherein SCSA 30, in accordance with the present disclosure, converts EV charging station 20 from a single vehicle charging station into a multiple vehicle charging station.

### Residential Vehicle Charging Load Management System

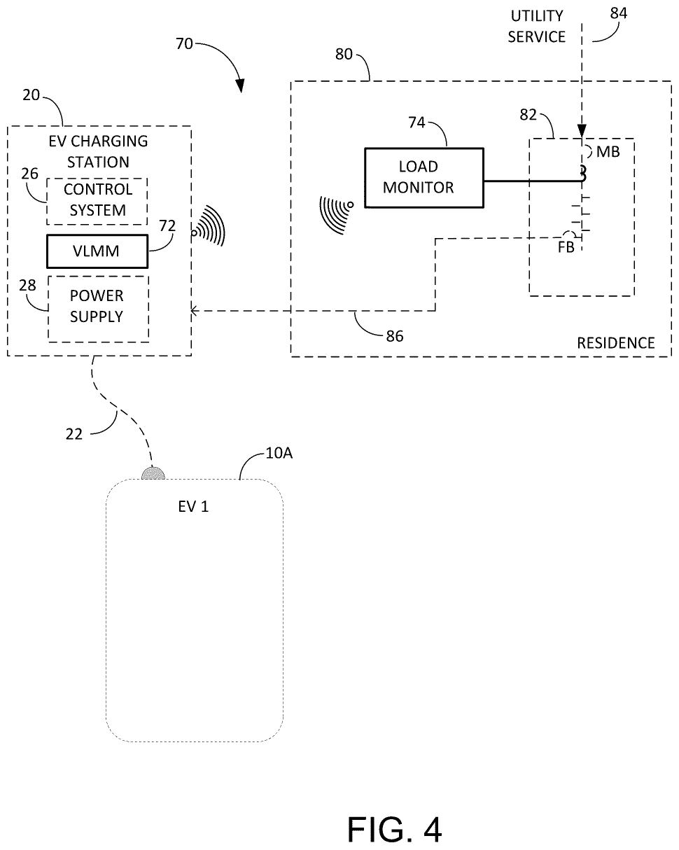

In other examples, as illustrated by FIG. 4, in addition to SCSA 30, the present disclosure also provides a residential vehicle charging load management system 70 to dynamically manage and control the power level provided by EV charging station 20 to charge EV 1 based on an amount of utility power that is available to be employed for vehicle charging at a given time. With reference to FIG. 4, a residence 80 has an electrical panel 82 that is fed by a utility service 84, wherein the electrical service has a maximum service capacity that is dictated by the ampacity of the utility service and electrical panel 82. For example, the electrical service may be a 120/240 VAC, 200-amp service, meaning that electrical panel 82 has a 200-amp, 2-pole main circuit breaker, MB, and has a maximum service capacity of 48 kW (48,000 watts). Additionally, residence 80 includes at least one EV charging station 20, which, as illustrated, may be located beyond residence 80, such as a garage or outdoors, and which is electrically supplied from electrical panel 82 via a circuit 86 protected by a feed circuit breaker, FB.

In one example, residential vehicle charging load management system 70 includes a vehicle load management module (VLMM) 72 coupled to EV charging station 20, and a load monitor 74 coupled to electrical panel 82. In examples, VLMM 72 is configured to communicate with control system 26 of EV charging station 20. In one example, as illustrated, VLMM may be disposed within EV charging station 20. In other examples, VLMM 72 may be located remotely from EV charging station 20. In examples, VLMM may communicate with control system 26 of EV charging station 20 via a wired or a wireless connection.

In operation, according to one example, load monitor 72 dynamically monitors the amount of power being used by residence 80 (which includes all household loads such as electric dryers, electric heaters, electric stoves/ovens, lighting, fans, etc.). Load monitor 72 transmits the power reading to VLMM 72 in an ongoing fashion. In one example, VLMM 72 compares the present load reading received from load monitor 72 to the maximum service capacity. According to examples, if the present load measurement is less than a predetermined threshold level, where, in one example, the predetermined threshold level is a percentage of the maximum service capacity (e.g., 80% of the maximum service capacity), VLMM 72 instructs control system 26 of EV charging station 20 to control power supply 28 to increase the rate of energy transfer to charge EV 1. In examples, the energy transfer rate is limited by the maximum transfer rate allowed by EV 1. Similarly, if the present load measurement is greater than the predetermined threshold level, VLMM 72 instructs control system 26 of EV charging station 20 to control power supply 28 to decrease the rate of energy transfer to charge EV 1. In some examples, if the present load measurement exceeds the predetermined threshold level, VLMM 72 instructs control system 26 of EV charging station 20 to suspend the charging of EV 1 until the power usage of residence 80 drops below the predetermined threshold level.

In other examples, VLMM 72 may be programmed to instruct control system 26 of EV charging station 20 to perform charging of EV 1 at selected times, such as within a selected time window (e.g., during utility off-peak hours). In some examples, VLMM 72 may communicate with the EV owner/homeowner, such as via a smartphone application, to provide status updates on EV charging operations (e.g., charging complete, whether charging is ongoing, whether charging has been suspended, etc.). In another example, based on the measured power usage of residence 80 by load monitor 74, the VLMM 72 dynamically adjusts the energy transfer rate (increases and decreases the energy transfer rate) so that a maximum energy transfer rate is maintained to EV 1 during a charging operation without exceeding the electrical capacity of the electrical service of residence 80.

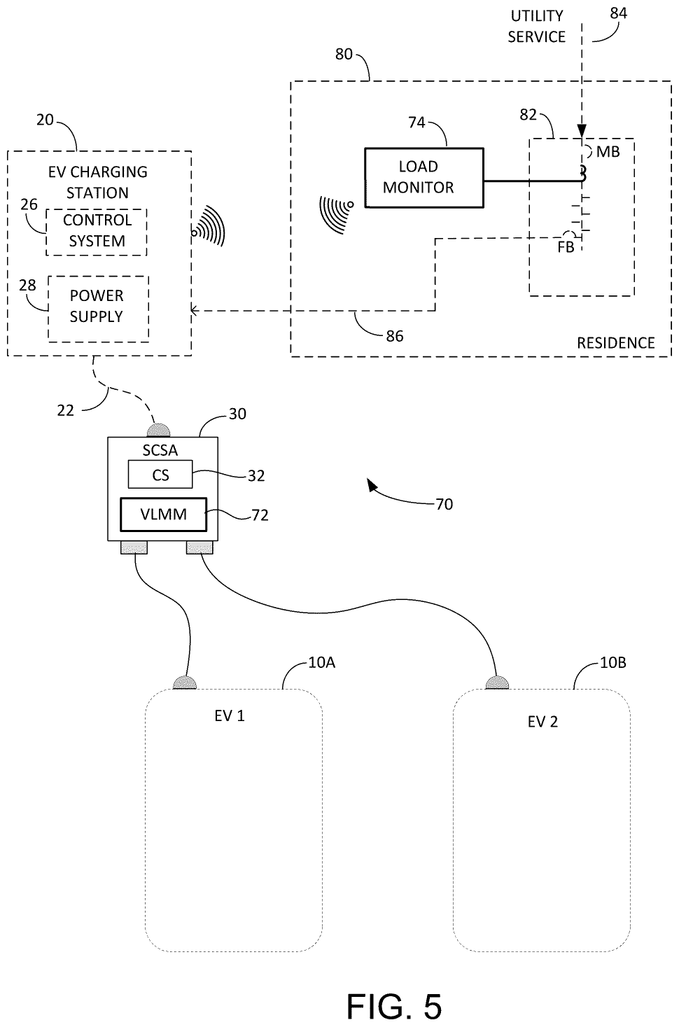

In some examples, as illustrated by FIG. 5, residential vehicle charging load management system 70 may be used in conjunction with, or be included as part of, smart charging station adapter (SCSA) 30. In such case, according to one example, VLMM 72 is included as part of SCSA 30, wherein residential vehicle charging load management system 70 operates as described above by FIG. 4, except that VLMM 72 communicates with control system 32 of SCSA 30 which, in-turn, communicates with control system 26 of EV charging station 20 to control power supply 28 to adjust the energy transfer rate to EV 1 or EV 2 via SCSA 30.

### Electric Vehicle Home Charging System with Load Management and Smart Metering

It is recognized that utilities may not be able to expand residential grids fast enough to accommodate home electric vehicle charging loads. The present invention is able to manage home charging loads based on load management factors both at the utility level and at the homeowner level while being able to charge an electric vehicle at a desired rate or within a desired time frame. In this manner, load management is controlled at the residential level to accommodate limits in capacity of residential power grids for electric vehicle charging.

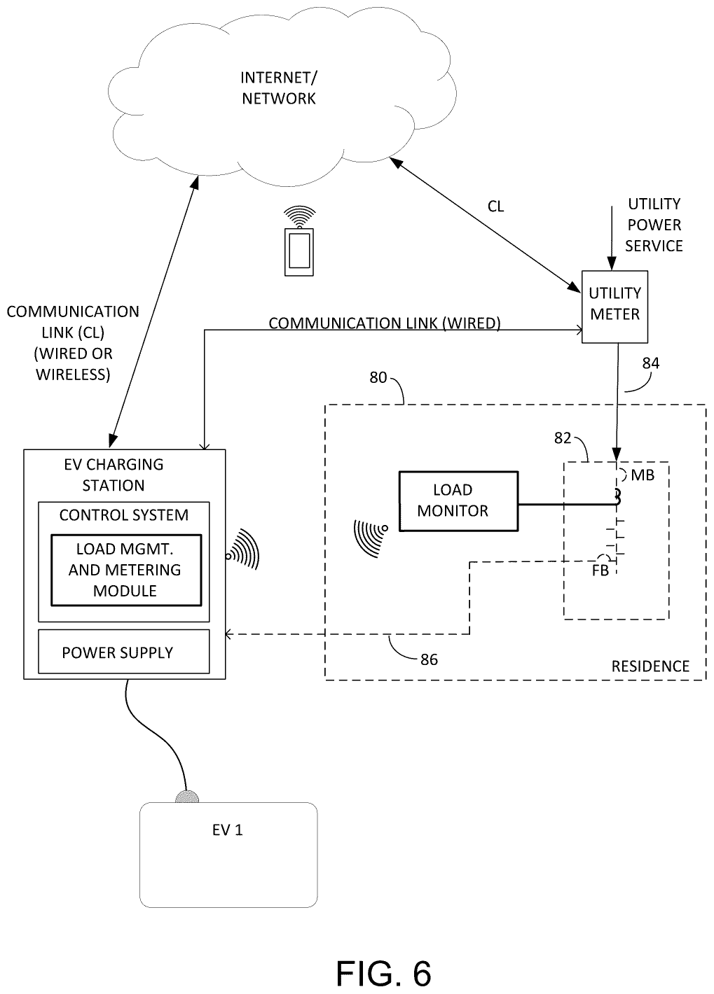

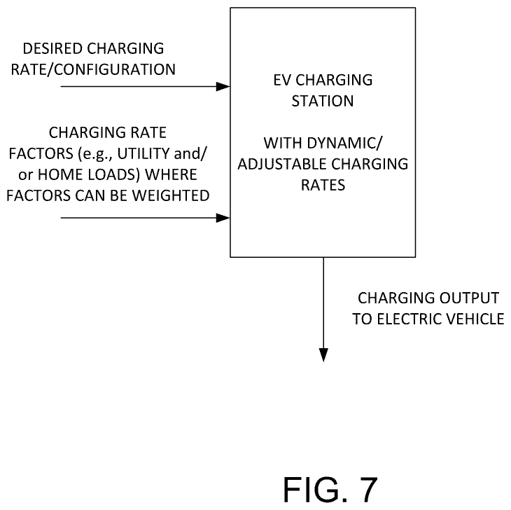

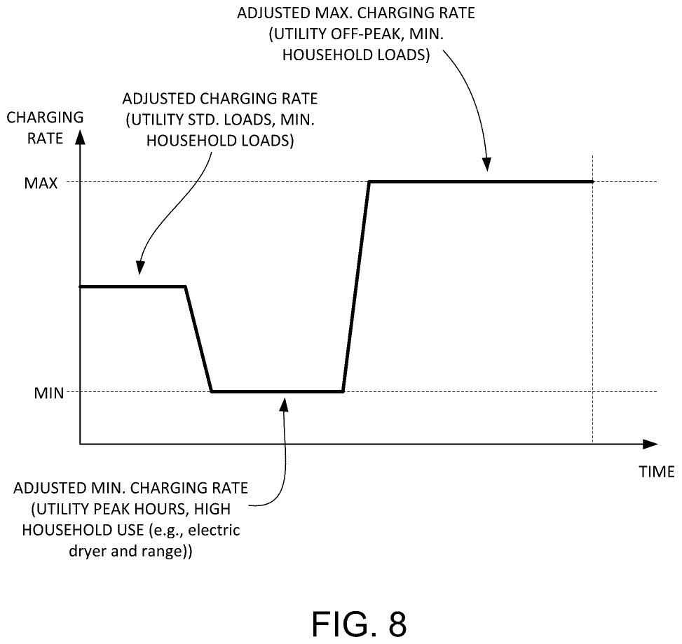

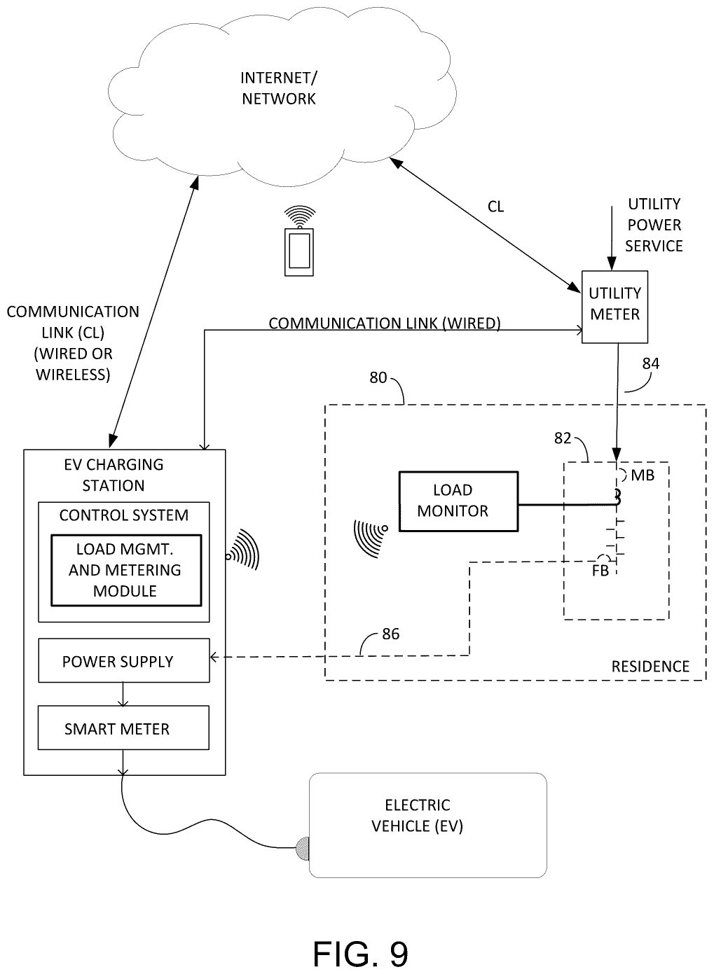

FIGS. 6-9 below provide an electric vehicle home charging system with load management for optimal charging of an electric vehicle. The charging system optimizes both charging load and charging costs. In some examples, the electric vehicle home charging system of FIGS. 6-9 further describes employing smart metering whereby residential energy usage employed for EV charging is separately metered in order to enable utility billing at a bill rate separate from a billing rate for other household loads. While FIGS. 1-5 provide a residential vehicle load charging load management system which is described and disclosed primarily as an add-on system to an existing EV charging station (i.e., an already installed EV charging station), the electric vehicle home charging system of FIGS. 6-9 is described primarily as having the load management features integrated within an EV charging station. However, it is noted that the concepts described by FIGS. 6-9 may also be configured as an add-on system to existing residential EV charging stations.

Dynamic Charging for Load Management. In one or more examples, the home charging system adjusts a rate at which an electric vehicle is charged to optimize charging of the electric vehicle. The rate of charging is adjustable (and optimized) based on factors provided from the utility and/or by actively monitoring the home electric load. A desired charging rate/configuration can be set up with the charging station. The charging station then can actively manage the charging output to an electric vehicle based on the desired charging parameters, the utility requirements, and the active electric load within the household. In one example, the charging rate can be dynamically adjusted during a charging session due to utility factors (utility load management) and homeowner load management (load on home electrical system such as running of an electric dryer, pumps, etc during charging of a vehicle).

Smart Metering. Additionally, the charging station can include a smart meter to optimize charging costs. In one example, the cost of electricity provided by the utility (rate) is less for electric charging than it is for providing electricity to the home. The smart meter separately meters the electricity used for charging of the electric vehicle. The homeowner electric costs are thereby reduced since the energy used for charging of the electric vehicle is a cheaper rate.

In other examples, the utility rate may also vary based on the time of day. The smart meter can be set up as a “black box” that is provided by the utility and only accessible by the utility. The black box can communicate directly to the utility and/or with the homeowner utility metering system.

Operation of the electric vehicle charging system may be done either local to the charging station or charging vehicle or remotely via a computer, ev control system, charging station control system, or a user control application located on a smart device (e.g., via a phone).

One or more examples and features of the charging system are detailed herein and illustrated at least in the FIGS. 6-9.

An Electric Vehicle Home Charging System with Optimized Charging can include a combination of one or more of the following features:

### Electric Vehicle Charging System

EV home charging system with load management.
Optimizes both charging load and charging costs.
Charging station can adjust the charging rate based on a number of factors.
Factors can include, for example, desired charging parameters, utility charging factors, and home electric load.
In one example, the charging system includes a smart meter for separately metering of the ev charging load for tracking electricity use for charging. The ev charging load is then charged at a reduced rate by the utility.
   Charging System with Load Management
EV Charging can be optimized based on multiple factors related to ev load management.
EV Charging Parameter factors can include, for example, desired time of charging (e.g., daytime or overnight), rate of charging (e.g., 2 hours, 4 hours, 12 hours, etc.), type of charging (e.g., AC level 2 charging, DC fast charging, etc.).
Utility Charging parameters can include varying utility rates based on charging time of day, cycling of charging (similar to Super Saver Switch on/off cycling of AC units in the summer), type of load, speed of charging, etc.), or simply the utility's need for power for use elsewhere.
Home electric load parameters, for example, can include time of day or active electric household load at the time of charging.
Adjustable Charging Rate. The charging rate can be actively adjusted as needed. For example, The charging rate can be adjusted based on utility needs and also ev user needs (e.g., a time by which the user needs to have the ev charged). The charging station can be operated at a faster rate if a quick charge is needed, or could be charged at a slower rate if charged overnight.
Defined Charging Rate. Charging station can communicate with the vehicle to charge the ev at a defined rate to meet a defined charging period, such as 2 hours, 4 hours, 12 hours, etc.
Household load. Can charge at different rates based on household load. The charging rates can be actively adjusted. For example, if an electric dryer is running and the household electric load is high an ev may be charged at a minimal rate. Once the household load is reduced (e.g., the electric dryer is finished drying), the ev charger is adjusted to charge at a much faster (i.e., higher) rate.
Dynamic Charging through an Active Adjustable Charging Rate. By actively adjusting the charging rate through load management, the household electric load can be managed while optimizing the ev charging rate. Load balancing is utilized where the charging load is actively checked and balanced for optimal use of charging capacity.
   Charging Station with Smart Metering for Separately Metered Charging Load
Smart Meter. A separate meter can be used to separately meter ev charging load from household electric load.
Charging Rate. In one example, the electricity used for charging an electric vehicle is a discounted rate when compared to the utility rate charged for household electricity. Homeowners receive a discount via the utility for electricity used to charge an electric vehicle.
Smart meter could be provided as a “black box” by the utility. Homeowner would not have access to smart meter.
Smart meter can communicate with the utility via a wired or wireless communication link. The communication link could be with a network, the Internet, or could be a communication link to the homeowner's utility meter.
Smart meter can be located at the charging station. Can be located on the power input or power output to/from the charging station.
Smart meter can be located at the utility meter or panel feed to the charging station. A separate meter can also be located at the charging station to verify power use for charging the electric vehicle.
Power used for charging of the electric vehicle could also be monitored by the electric vehicle and communicated to the utility (e.g., the utility metering system for tracking ev charging electricity use vs home electricity use).
The ev charging system and utility home metering system all communicate with each other, either directly or via a network link with a utility.
The utility can communicate with the charging system, and charges a different (i.e., discounted) electricity rate for the load related to ev charging vs other household loads.
In summary, electric vehicle charging at home can be separately metered from the rest of the home. The metering can take place at the charging station, at the home panel feed, at the utility meter, or at the electric vehicle. Utility would give a better rate for electricity used for charging of electric vehicle. In addition, the utility could give a better rate or credit for electric vehicle charging that takes place during off peak hours for power use.
Systems can be put in place such that users may not “cheat the system” and connect additional loads to the electric vehicle charging load such that they are charged at a different (i.e., reduced) electricity rate.
For one or more reasons it may be desirable for the smart meter black box to be inaccessible to a home user. True readings are needed that reflect only electricity used for electric vehicle charging. For example, the black/smart box can be configured to only communicate with the utility. The smart box can be configured to handshake with the electric vehicle prior to closing connection/metering of electricity use between the electric vehicle and the charging station.
A check could be set up between the electric vehicle and smart box to confirm power transferred from the charging station equals power received by the electric vehicle. Once a check is confirmed/verified, charging and charging metering can be enabled.
Electric vehicle electricity charging use could be separately metered by software at the electric vehicle. The electric vehicle could report and confirm electricity use vor battery charging software using a communication link between the electric vehicle and the charging station, and or the utility.
This would be different but could be in addition to the use of AC switches by a utility to cycle AC units during peak power use times. A similar switch could also be put on the electric vehicle charging station.

It is recognized that the charging system of the present disclosure can be configured for use in many charging system applications, including those not disclosed herein.

The ideas of the present application can be applied to home electrical systems, and also to other facilities such as industrial or municipal facilities for load management and smart metering.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. A charging station adapter for an EV charging station comprising:
a switching module including a plurality of controllable switches, the switching module to receive a charging output of the EV charging station, an upstream side of each controllable switch connected to the charging output of the EV charging station, and the downstream side of each controllable switch to electrically connect to a corresponding electric vehicle; and
a control system to receive vehicle charging information from each electric vehicle connected to a corresponding one of the controllable switches, and, based on the received vehicle charging information the control system to:
select one or more of the electric vehicles connected to the controllable switches for charging;
communicate charging instructions based on the received charging information of the one or more selected electric vehicles to the EV charging station to direct parameters of the charging output to be provided by the EV charging station; and
close the controllable switches corresponding to the one or more selected electric vehicle to provide the charging output of the EV charging station to the one or more selected electric vehicles to charge the one or more selected electric vehicle, the remaining controllable switches being in an open position.

2. (canceled)

3. The charging station adapter of claim 1, when multiple electric vehicles are simultaneously connected to corresponding ones of the controllable switches, and based on the vehicle charging information received from each of the connected electrical vehicles the control system determines to charge the connected electrical vehicles in a sequential charging order, for each electric vehicle in the sequential charging order, the control system to perform a charging procedure of a current vehicle of the sequential charging order including to:
communicate charging instructions for a current electric vehicle of the sequential charging order to the EV charging station;
close the corresponding controllable switch to current electric vehicle of the sequential charging order to provide the EV charging station output thereto; and
upon completion of charging of the current electric vehicle, to:
open the corresponding controllable switch of the current electric vehicle of the sequential charging order; and
repeat the charging procedure for the next electric vehicle of the sequential charging order.

4. The charging station adapter of claim 1, when multiple electric vehicles are simultaneously connected to corresponding ones of the controllable switches, and based on the vehicle charging information received from each of the connected electrical vehicles the control system determines to charge the connected electrical vehicles in parallel, the control system to:
communicate charging instructions to the electric vehicle charging station;
close the controllable switches corresponding to each of the electric vehicles to be charged in parallel; and
upon completion of charging of the current electric vehicle, open the controllable switches corresponding to each of the electric vehicles charged in parallel.

5. The charging station adapter of claim 1, wherein the vehicle charging information for each electric vehicle includes one or more of at least a charging voltage, charging current level, present battery charge level, desired completed battery charge level, and estimated time of next use of the electric vehicle.

6. The charging station adapter of claim 1, wherein the charging instructions include one or more of at least a charging voltage level and a current level.

7. The charging station adapter of claim 7, wherein the charging instructions include a voltage level and current level for a trickle charging operation.

8. The charging station adapter of claim 7, wherein the charging instructions include a voltage level and current level for a fast charging operation.

9. The charging station adapter of claim 1, further including an output port corresponding to and connected electrically downstream of each controllable switch, each output port configured to couple to an electrical charging cable for electrical connection to an electric vehicle.

10. The charging station adapter of claim 1, the control system to communicate with the vehicle charging station and an electric vehicle via at least one of a wired connection and a wireless connection.

11. A charging station adapter for use with an EV charging station, comprising:
an input port to couple to a charging plug of a charging cable of the EV charging source to receive an electrical charging output of the EV charging station;
a first output port and a second output port each connectable via a corresponding charging cable to corresponding first and second electric vehicles;
a first controllable switch electrically connected between the input port and the first output port;
a second controllable switch electrically connected between the input port and the second output port; and
a smart charging controller to receive vehicle charging information from the first and second electrical vehicles connected to the first and second output ports and, based on the received vehicle charging information to
select one of the first and second electric vehicles for charging;
communicate charging instructions for the selected one of the electric vehicles to the EV charging station to direct selected parameters of the electric charging output of the EV charging station; and
close the controllable switch corresponding to the selected one of the first and second electric vehicles to provide the charging output of the EV charging station to the selected one of the electric vehicles to charge a battery thereof.

12. The charging station adapter of claim 11, wherein upon charging of the selected one of the first and second electric vehicles being completed, the control system to:
open the controllable switch corresponding to the selected one of the first and second electric vehicles;
communicate the charging information of the other of the first and second electric vehicles to the EV charging station to direct selected parameters of the electric charging output of the EV charging station; and
close the controllable switch corresponding to the other of first and second electric vehicles to provide the charging output of the EV charging station to the other of the first and second electric vehicles to charge a battery thereof.

13. The charging station adapter of claim 1, wherein the vehicle charging information for each electric vehicle includes one or more of at least a charging voltage, charging current level, present battery charge level, desired completed battery charge level, and estimated time of next use of the electric vehicle.

14. The charging station adapter of claim 11, wherein the charging instructions include one or more of at least a charging voltage level and a current level.

15. The charging station adapter of claim 14, wherein the charging instructions include a voltage level and current level for a trickle charging operation.

16. The charging station adapter of claim 14, wherein the charging instructions include a voltage level and current level for a fast charging operation.

17. A smart charging station adapter for use with an EV charging station, comprising:
a switching module including a number of controllable switches, the switching module to receive the charging output of the EV charging station, an upstream side of each controllable switch connected to the charging output of the EV charging station, and the downstream side of each controllable switch to connect to a corresponding electric vehicle via a charging cord; and
a control system to receive charging information from the the electric vehicles connected to the controllable switches, based on the received charging information the control system to:
select one of the electric vehicles connected to the controllable switches for charging;
communicate the charging information of the selected electric vehicle to the EV charging station to direct the EV charging station to adjust parameters of the charging output; and
close the controllable switch corresponding to the selected electric vehicle to provide the charging output of the EV charging station to the selected electric vehicle to charge the selected electric vehicle after opening the remaining controllable switches.

18. The charging station adapter of claim 17, wherein upon charging of the selected vehicle being completed, the control system to:
open the controllable switch corresponding to the selected vehicle;
select a next one of the electric vehicles connected to the controllable switches;
communicate the charging information of the selected next one of the electric vehicles to the EV charging station to direct the EV charging station to adjust parameters of the charging output; and
close the controllable switch corresponding to the selected next one of the electric vehicles to provide the charging output of the EV charging station to the selected next one of the electric vehicles to charge the selected next one of the electric vehicles.

19. The smart charging station adapter of claim 17, wherein the vehicle charging information for each electric vehicle includes one or more of at least a charging voltage, charging current level, present battery charge level, desired completed battery charge level, and estimated time of next use of the electric vehicle.

20. The smart charging station adapter of claim 19, wherein the charging instructions include one or more of at least a charging voltage level and a current level.
